(19) United States
(12) Patent Application Publication
(10) Pub. No.: US 2025/0052083 A1
(43) Pub. Date: Feb. 13, 2025

(54) POOL FILLING APPARATUS

(71) Applicant: Solomon Thomson, Oceanside, CA (US)

(72) Inventor: Solomon Thomson, Oceanside, CA (US)

(21) Appl. No.: 18/796,070

(22) Filed: Aug. 6, 2024

Related U.S. Application Data
(60) Provisional application No. 63/517,975, filed on Aug. 7, 2023.

(51) Int. Cl. E04H 4/14; F16K 21/18

(52) U.S. Cl. CPC E04H 4/14; F16K 21/185

(57) ABSTRACT

A pool filling apparatus has a housing with a housing interior surrounded by an exterior surface. A water inlet port and a water outlet port are each disposed on the exterior surface for receiving and discharging water, respectively. A vertically adjustable sensor is coupled to the housing for sensing a water height of the pool and is configurable into a position vertically below the housing. A flow regulation subsystem is disposed within the housing interior and includes a conduit disposed between the water inlet port and the water outlet port, and a valve disposed in-line with the conduit between the water inlet port and water outlet port. The valve is electrically coupled to the sensor such that the sensor is configured to send a signal to the valve to change the valve from an open state to a closed state thereby preventing the water outlet port from discharging water.

### CROSS-REFERENCE TO RELATED APPLICATIONS

This application claims benefit of priority with U.S. Provisional Application Ser. No. 63/517,975, filed Aug. 7, 2023; the entire contents of which are hereby incorporated by reference.

### BACKGROUND

### Field of the Invention

This invention relates to pool refilling apparatus; more particularly, a pool filling apparatus designed for transportability and ease of setup.

### Description of the Related Art

Pools and similar vessels require filling with water after events such as new construction or repairs and maintenance. Filling an empty pool can be time consuming and usually requires a person to monitor the filling process to prevent overfilling and flooding. There exist solutions to the filling process that don't require a person to monitor, such as U.S. Pat. No. 10,337,201 (Thomson). However, current solutions do not provide a feasible and commercially available solution that is easy to transport as well as easy to setup and take down.

### SUMMARY

The disclosure concerns a pool filling apparatus. The pool filling apparatus comprises a housing having an exterior surface and a housing interior surrounded by the exterior surface. The exterior surface comprises a bottom surface and a plurality of sides including a first side and a second side. A water inlet port is disposed on the exterior surface and is configured to engage with an external hose for receiving and communicating water into the housing interior. A water outlet port is disposed on the exterior surface and is fluidly coupled with the water inlet port to discharge water into a pool. A vertically adjustable sensor is coupled to the housing. The vertically adjustable sensor is adapted to sense a water height of the pool, wherein the vertically adjustable sensor is configurable into a position vertically below the bottom surface of the housing. The pool filling apparatus further comprises a flow regulation subsystem disposed within the housing interior. The flow regulation subsystem comprises a conduit disposed between the water inlet port and the water outlet port, and a valve disposed in-line with the conduit between the water inlet port and water outlet port, wherein the valve is electrically coupled to the vertically adjustable sensor. The vertically adjustable sensor is configured to send a signal to the valve to change the valve from an open state to a closed state thereby preventing the water outlet port from discharging water.

In some embodiments, the pool filling apparatus may comprise a plurality of water inlet ports and a plurality of water outlet ports, wherein each pair of water inlet ports and water outlet ports comprises a conduit with a corresponding in-line valve.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a top view of a pool filling apparatus in accordance with a first illustrated embodiment;

FIG. 2 shows a front view of the pool filling apparatus according to the first illustrated embodiment;

FIG. 3 shows a perspective view of the pool filling apparatus according to the first illustrated embodiment;

FIG. 4 shows an alternate front view of the pool filling apparatus according to the first illustrated embodiment;

FIG. 5 shows a rear view of the pool filling apparatus according to the first illustrated embodiment;

FIG. 6 shows a side view of the pool filling apparatus according to the first illustrated embodiment;

FIG. 7 shows a perspective of a vertically adjustable sensor according to the first illustrated embodiment;

FIG. 8 shows a top view of a flow regulation subsystem according to the first illustrated embodiment;

FIG. 9 shows a block diagram of the flow regulation subsystem according to the first illustrated embodiment; and

FIG. 10 shows a perspective view of the housing interior of the pool filling apparatus according to the first illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

Unless explicitly defined herein, terms are to be construed in accordance with the plain and ordinary meaning as would be appreciated by one having skill in the art.

### General Description of Embodiments

In one general embodiment, a pool filling apparatus is disclosed. The pool filling apparatus comprises a housing having an exterior surface and a housing interior surrounded by the exterior surface. The exterior surface comprises a plurality of sides, a bottom surface, and a hosing lid hingedly coupled to one of the plurality of sides, wherein the plurality of sides includes a first side and a second side opposite the first side. A water inlet port is disposed on the first side and is configured to engage with an external hose for receiving and communicating water into the housing interior. A water outlet port is disposed on the second, wherein the water outlet port is fluidly coupled with the water inlet port and is configured to discharge water into a pool. The pool filling apparatus further comprises a vertically adjustable sensor coupled to the housing and is adapted to sense a water height of the pool, wherein the vertically adjustable sensor is configurable into a position vertically below the bottom surface of the housing. A slider receptable is disposed on the second side and slidably engages with a slider. The slider extends from a first end to a second end, wherein each portion of the first end is configured to slide within and be surrounded by the slider receptacle. The slider is configured to detach and fully separate from each of the slider receptacle and the vertically adjustable sensor. A flow regulation subsystem is disposed within the housing interior. The flow regulation subsystem comprises a conduit and a valve. The conduit is disposed between the water inlet port and the water outlet port, and the valve is disposed in-line with the conduit between the water inlet port and water outlet port, wherein the valve is electrically coupled to the vertically adjustable sensor. A removable tray is disposed within the housing interior above the flow regulation subsystem, wherein the removable tray is configured to hold the vertically adjustable sensor and the slider. The vertically adjustable sensor is configured to send a signal to the valve upon sensing a threshold of a pool water level to change the valve from an open state to a closed state thereby preventing the water outlet port from discharging water.

In some embodiments, the pool filling apparatus may further comprise a plurality of water inlet ports, wherein each of the water inlet ports is disposed on the first side. The pool filling apparatus may further comprise a plurality of water outlet ports, wherein each of the water outlet ports is disposed on the second side. The first side may be in parallel alignment with the second side.

In some embodiments, the pool filling apparatus may further comprise a sensor mounting clamp disposed at the second end of the slider, the sensor mounting clamp configured to slidably couple with the vertically adjustable sensor.

In some embodiments, the slider may extend orthogonally from the second side.

In some embodiments, the pool filling apparatus may further comprise a sensor stem extending from a proximal end to a distal end, the distal end comprising the vertically adjustable sensor, wherein the sensor stem detachably couples to the slider. The pool filling apparatus may further comprise a sensor wire connector electrically coupled to each of the vertically adjustable sensor and the flow regulation subsystem. The sensor wire connector may extend through the proximal end of the sensor stem. The sensor wire connector may be externally accessible from the exterior surface of the housing.

In some embodiments, the slider receptacle may extend through each of first side and the second side.

In some embodiments, the water outlet port may be linearly aligned with the water inlet port wherein the conduit disposed therebetween comprises a linear configuration.

In some embodiments, the water outlet port may comprise threading configured to engage with an external hose.

In some embodiments, the slider receptacle may further comprise an opening having a same periphery as the slider such that the slider is configured to slide horizontally in and out of the slider receptacle while preventing rotation of slider within the slider receptacle.

In another general embodiment, a pool filling apparatus is disclosed. The pool filling apparatus comprises a housing having an exterior surface and a housing interior surrounded by the exterior surface. The exterior surface comprises a plurality of sides and a bottom surface, wherein the plurality of sides includes a first side and a second side. A water inlet port is disposed on the exterior surface and is configured to engage with an external hose for receiving and communicating water into the housing interior. A water outlet port is disposed on the exterior surface, wherein the water outlet port is fluidly coupled with the water inlet port and configured to discharge water into a pool. A vertically adjustable sensor is coupled to the housing, the vertically adjustable sensor is adapted to sense a water height of the pool is configurable into a position vertically below the bottom surface of the housing. The pool filling apparatus further comprises a flow regulation subsystem disposed within the housing interior, the flow regulation subsystem comprises a conduit disposed between the water inlet port and the water outlet port, and a valve disposed in-line with the conduit between the water inlet port and water outlet port, wherein the valve is electrically coupled to the vertically adjustable sensor. The vertically adjustable sensor is configured to send a signal to the valve to change the valve from an open state to a closed state thereby preventing the water outlet port from discharging water.

In some embodiments, the water inlet port and the water outlet port may each be disposed on the plurality of sides.

In some embodiments, the water inlet port may be disposed on the first side. The water outlet port may be disposed on the second side. The first side may be opposite the second side.

In some embodiments, the pool filling apparatus may further comprise a plurality of water inlet ports, wherein each of the water inlet ports is disposed on the first side. The pool filling apparatus may further comprise a plurality of water outlet ports, wherein each of the water outlet ports is disposed on the second side. The first side may be in parallel alignment with the second side.

In some embodiments, the pool filling apparatus may further comprise a slider receptable disposed on one of the plurality of sides, a slider slidably engaged with the slider receptacle, and a sensor mounting clamp disposed on the slider. The slider may extend from a first end to a second end, wherein the first end is configured to slide within the slider receptacle. The sensor mounting clamp may be disposed at the second end of the slider, the sensor mounting clamp configured to slidably couple with the vertically adjustable sensor.

In some embodiments, the slider may extend orthogonally from the exterior surface of the housing. The slider may extend orthogonally from one of the plurality of sides.

In some embodiments, the slider may be configured to detach and fully separate from the slider receptacle.

In some embodiments the vertically adjustable sensor may be configured to detach and fully separate from the sensor mounting clamp.

In some embodiments, the slider receptable and the water output port may each be disposed on the second side.

In some embodiments, the pool filling apparatus may further comprise a sensor stem extending from a proximal end to a distal end, the distal end comprising the vertically adjustable sensor, wherein the sensor stem detachably couples to the sensor mounting clamp.

In some embodiments, the pool filling apparatus may further comprise a sensor wire connector electrically coupled to each of the vertically adjustable sensor and the flow regulation subsystem. The sensor wire connector may extend through the proximal end of the sensor stem. The sensor wire connector may be externally accessible from the exterior surface of the housing.

In some embodiments, the slider receptacle may surround each portion of the first end.

In some embodiments, the slider receptacle may extend through each of first side and the second side wherein the first side is opposite the second side.

In some embodiments, the slider receptacle may further comprise an opening having a same periphery as the slider such that the slider is configured to slide horizontally in and out of the slider receptacle while preventing rotation of slider within the slider receptacle.

In some embodiments, the pool filling apparatus may further comprise a removable tray disposed within the housing interior above the flow regulation subsystem, the removable tray configured to hold the vertically adjustable sensor and the slider.

In some embodiments, the pool filling apparatus may further comprise a housing lid hingedly coupled to one of the plurality of sides.

In some embodiments, the water outlet port may be linearly aligned with the water inlet port wherein the conduit disposed therebetween comprises a linear configuration.

In some embodiments, the water outlet port may comprise threading configured to engage with an external hose.

### Manufacturing

The valves can be obtained commercially, for example and without limitation PGV-100-G-S (https://hunterindustries.com/irrigation-product/1-pgv/pgv-100-g-s). Alternatively, the shield can be customized in accordance with the level and knowledge of one having skill in the art

Each of the components of the pool filling apparatus described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

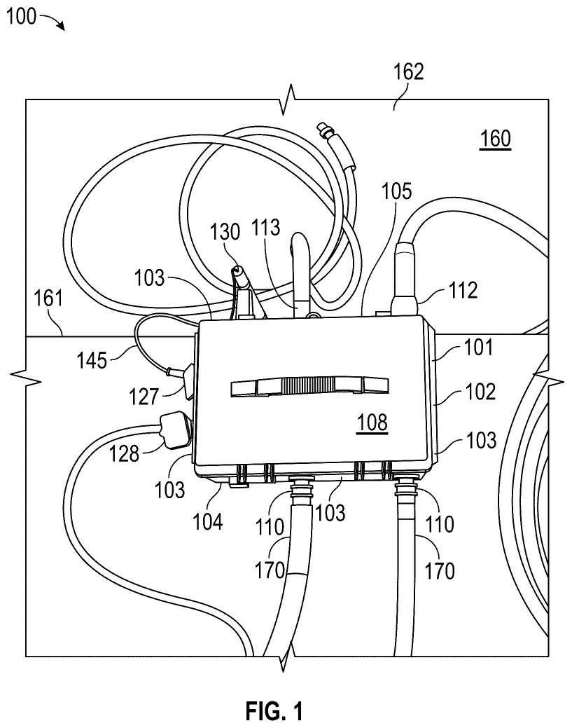

FIG. 1 shows a top view of a pool filling apparatus (100) in accordance with a first illustrated embodiment. The pool filling apparatus (100) comprises a housing (101) having an exterior surface (102) including a plurality of sides (103), a housing lid (108), and a bottom surface (106) (not shown). A housing interior (107) (not shown) is surrounded by the exterior surface. The plurality of sides includes a first side (104) and a second side (105) opposite the first side. The first side comprises a first water inlet port (110) and a second water inlet port (111). Both the first and second water inlet ports are engaged with external hoses (170) for receiving water. The second side comprises a first water outlet port (112) and a second water outlet port (113). The first water outlet port is fluidly coupled to the first water inlet port and the second water outlet port is fluidly coupled to the second water inlet port such that water received by the first water inlet port is discharged by the first water outlet port and water received by the second water inlet port is discharged by the second water outlet port. The apparatus further comprises a vertically adjustable sensor (130) coupled to the second side. The vertically adjustable sensor is configured to position vertically below the bottom surface and is adapted to detect a surface of water.

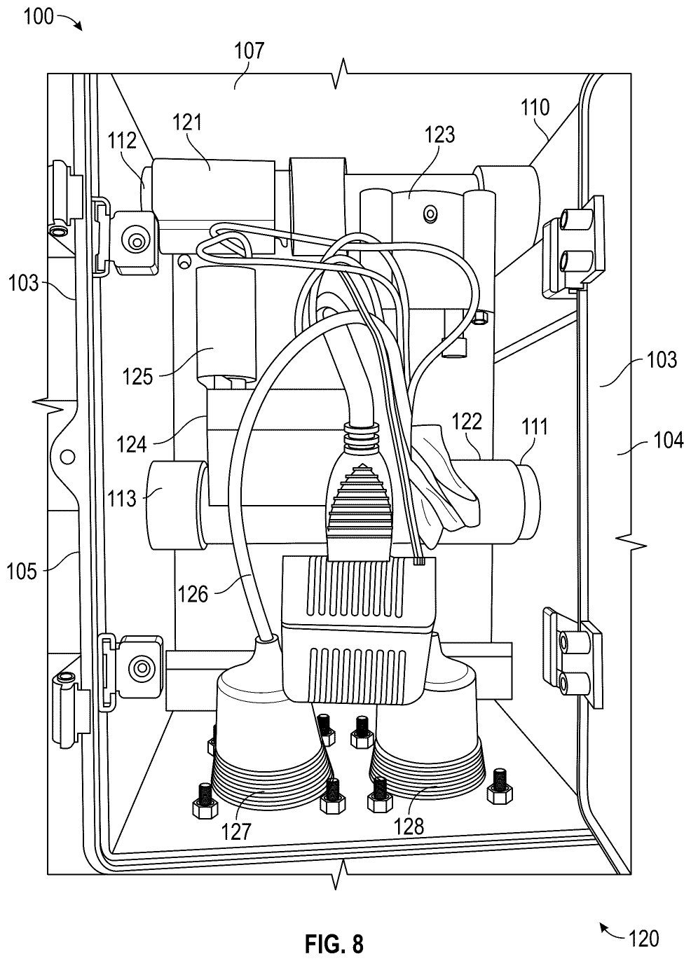

The pool filling apparatus (100) is positioned adjacent to a pool (160) at a pool edge (161). The first water outlet port (112) and the second water outlet port (113) are facing inward towards a pool wherein water discharged by the first and second water outlet ports enters a pool interior (162). As the pool fills up with water, the vertically adjustable sensor (130) is configured to detect as the water approaches near the pool edge. Once the water is detected, the sensor sends a signal via a sensor wire connector (145) to a sensor wire receptacle (127) for transmission into the housing interior (107). Disposed within the housing interior is a flow regulation subsystem (FIG. 8; 120) wherein upon reception of the signal by the sensor, the flow regulation subsystem is configured to shut off the flow to both the first water outlet port and the second water outlet port. The pool filling apparatus further comprises a power inlet (128) for providing power for both the flow regulation subsystem and the vertically adjustable sensor.

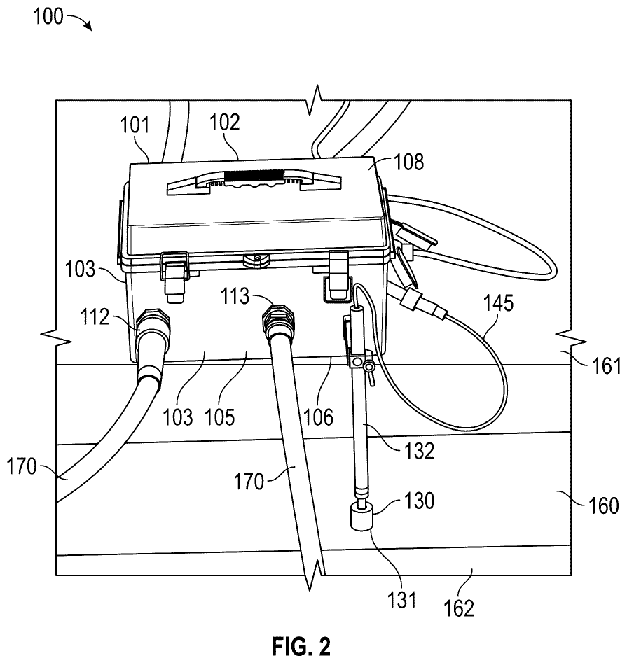

FIG. 2 shows a front view of the pool filling apparatus (100) disposed at a pool edge (161) of a pool (160) according to the first illustrated embodiment. The pool filling apparatus comprises a housing (101) having an exterior surface (102). The exterior surface further comprises a plurality of sides (103), a bottom surface (106), and a housing lid (108). Disposed on a second side (105) is a first water outlet port (112) and a second water outlet port (113). Each of the first water outlet port and the second water outlet port is engaged with external hoses (170) for discharging water into the pool. The pool filling apparatus further comprises a sensor (130) coupled to the housing at the second side. The sensor is configured to vertically adjust such that the sensor can be positioned into a pool interior (162) of the pool at a level below the pool edge. The vertically adjustable sensor comprises a sensor stem (132) that is configured to slide upwards and downwards based on a desired height by the user.

As shown, the vertically adjustable sensor (130) comprises a float sensor (131) for activating a flow regulation subsystem (FIG. 8; 120) disposed within the housing (101). When water level in the pool (160) rises to trigger the float sensor, a signal is sent through a sensor wire connector (145) to the flow regulation subsystem. Other sensors may be also be utilized. For example, and without limitation, the sensor may comprise a capacitive sensor, a conductive sensor with multiple probes, a laser sensor, an ultrasonic sensor, a pressure sensor, a radar sensor, or an optical sensor.

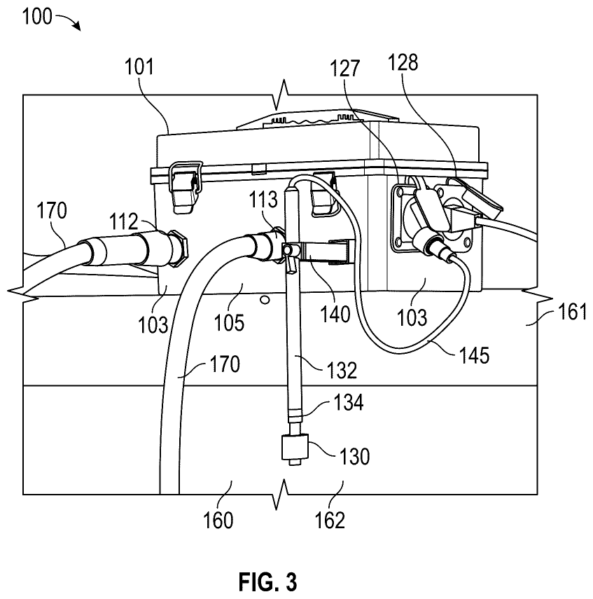

FIG. 3 shows a perspective view of the pool filling apparatus (100) positioned at a pool edge (161) of a pool (160) according to the first illustrated embodiment. The pool filling apparatus is configured to discharge water into a pool interior (162) through a first water outlet port (112) and a second water outlet port (113). One having skill in the art will appreciate that alternative number of water outlet ports can be utilized, including one or more than two. The first and second water outlet ports are coupled to a housing (101) at a second side (105). Further coupled to the second side is a slider (140) extending orthogonally therefrom to overhang the pool edge. Slidably coupled to the slider is a sensor stem (132) which is configured to move vertically upwards and downwards along the slider. A vertically adjustable sensor (130) is disposed at a distal end (134) of the sensor. A sensor wire connector (145) extends from a proximal end (133) of the sensor stem and detachably couples with a sensor wire receptacle (127) disposed on a lateral side of the housing. The vertically adjustable sensor and sensor stem are configured to detach and fully separate from the slider, and the sensor wire connector is configured to detach and fully separate from the sensor wire receptacle in order for the vertically adjustable sensor, the sensor stem, and the sensor wire connector to be removed for storage and transportability. In some embodiments, the vertically adjustable sensor is fixedly coupled to the sensor stem and the sensor wire connector is fixedly coupled to at least one of the vertically adjustable sensor or the sensor stem to form a sensor assembly. Disposed adjacent to the sensor wire receptacle on the same side is a power inlet (128).

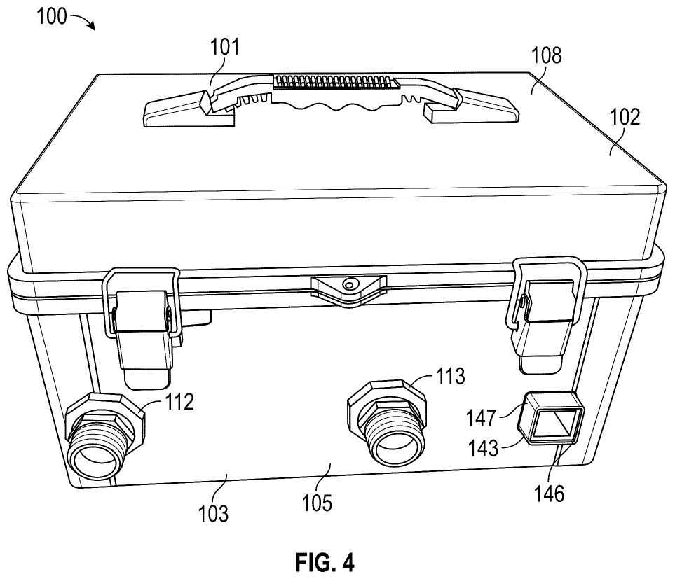

FIG. 4 shows an alternate front view of the pool filling apparatus (100) according to the first illustrated embodiment. The pool filling apparatus comprises a housing (101) with a housing lid (108) and a plurality of sides (103) including a second side (105). Externally accessible from the second side is a first water outlet port (112) and a second water outlet port (113) for discharging water. A slider receptacle (143) is also disposed on the second side for receiving and engaging with a slider (FIG. 3; 140). The slider receptacle comprises an opening (146) having a same periphery as the slider such that the slider can slide horizontally in and out of the slider receptacle while preventing rotation of the slider while within the slider receptacle.

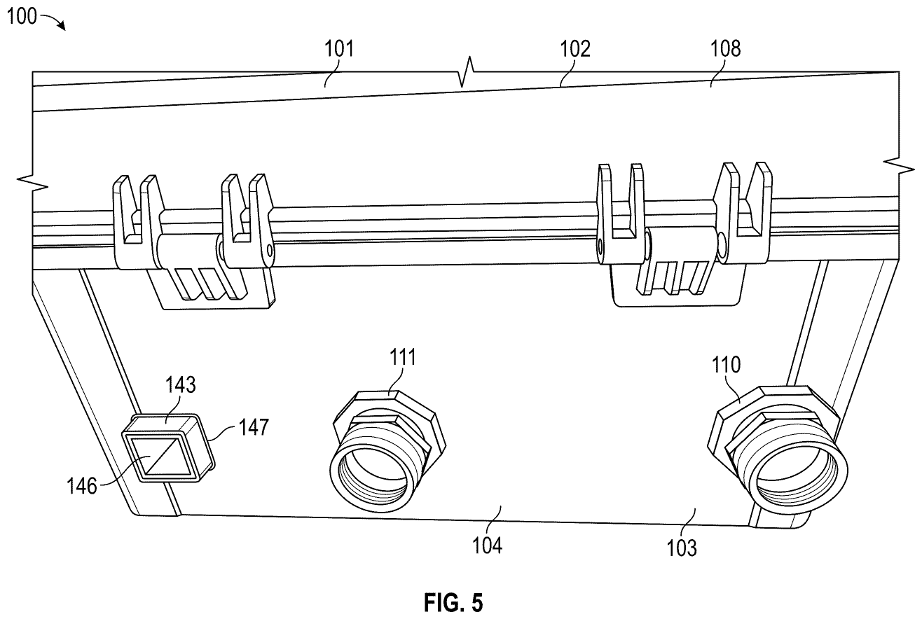

FIG. 5 shows a rear view of the pool filling apparatus (100) according to the first illustrated embodiment. The pool filing apparatus comprises a housing (101) with an exterior surface (102) including a housing lid (108) and a plurality of sides (103). The plurality of sides includes a first side (104) having a first water inlet port (110) and a second water inlet port (111). A rear end (147) of a slider receptacle (143) is shown protruding from the first side to provide a rigid and level formation to a slide (FIG. 3; 140) used at a second side, opposite the first side.

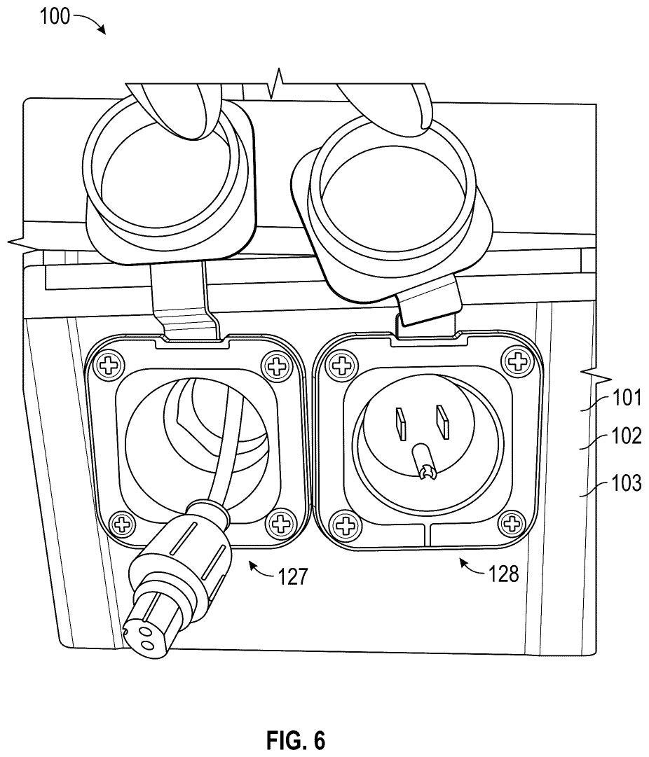

FIG. 6 shows a side view of the pool filling apparatus (100) according to the first illustrated embodiment. The pool filling apparatus includes a housing (101) with an exterior surface (102) including a plurality of sides (103). At one of the plurality of sides is a sensor wire receptacle (127) and a power inlet (128). The sensor wire receptacle is shown without a corresponding sensor wire connector (FIG. 3; 146) which has been decoupled. The sensor wire receptacle can be closed and scaled to protect componentry extending out of the sensor wire receptacle as well as contents within the housing. The power inlet is configured to receive power for components, including a sensor and a flow regulation subsystem (FIG. 8; 120). The power inlet may be configured to receive AC, DC, or both. In some embodiments, the pool filling apparatus may comprise a battery in addition to or in replacement of the power inlet.

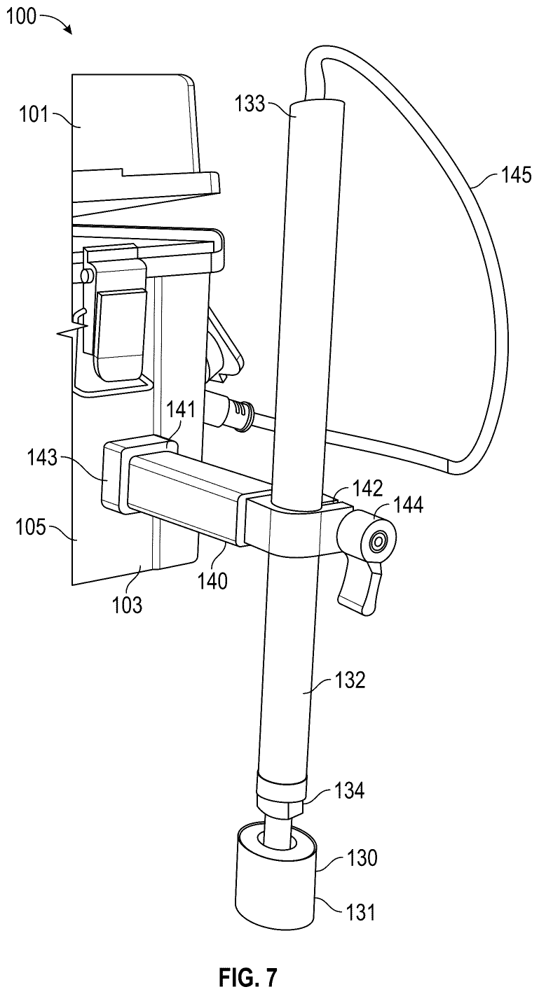

FIG. 7 shows a perspective of a vertically adjustable sensor (130) of the pool filling apparatus (100) according to the first illustrated embodiment. The vertically adjustable sensor includes a sensor stem (132) extending from a proximal end (133) to a distal end (134), wherein the vertically adjustable sensor is disposed on the distal end. Extending from the proximal end is a sensor wire connector (145) for sending a signal to the pool filling apparatus. The sensor stem is held in a vertical and upright position by a slider (140) extending horizontally from a second side (105) of a housing (101). The slider extends from a first end (141) to a second end (142). The second end comprises a sensor clamping mount (144) for slidable engagement with the sensor stem. The first end is configured to slidably engage with a slider receptacle (143) disposed on the second side such that the slider receptacle surrounds each portion of the first end. The vertically adjustable sensor further comprises a float sensor (131) for determining a water level in a pool. Other sensors may also be utilized as can be appreciated by one having skill in the art. In some embodiments, the slider, the sensor stem, or both may comprise an articulating arm for positioning the vertically adjustable sensor into a desired position and elevation.

FIG. 8 shows a top view of a flow regulation subsystem (120) of the pool filling (100) apparatus according to the first illustrated embodiment. The flow regulation subsystem is disposed within a housing (101) at a housing interior (107), wherein the housing interior is surrounded by each of a plurality of sides (103), a housing lid (108), and a bottom surface (106). The flow regulation subsystem comprises a first conduit (121) and a second conduit (122). The first conduit fluidly couples a first water inlet port (110) to a first water outlet port (112). Similarly, the second conduit fluidly couples a second water inlet port (111) to a second water outlet port (113). The flow regulation subsystem further comprises a first valve (123) disposed in-line with the first conduit, and a second valve (124) disposed in-line with the second conduit. The first and second valves are each configured to receive a signal from a signal transmission line (126) to switch the first and second valves from an open state to a closed state. Receiving the signal for switching states can include various logical inputs including receiving an on signal that was initially off, as well as receiving an off signal that was initially on. Switching of the states can be done by a myriad of mechanical and electrical means including a solenoid (125). The signal transmission line extends from a sensor wire receptacle (127) where the sensor wire receptacle receives a sensor signal for a sensor disposed externally from the housing. A power inlet (128) is configured to receive and distribute power for various components including the first valve and the second valve. The first and second conduits each comprise a linear configuration such that water flowing through the first and second conduits each have a linear and straight flow pattern. The first and second valves are shown staggered relative to each other to provide a compact form factor of the pool filling apparatus.

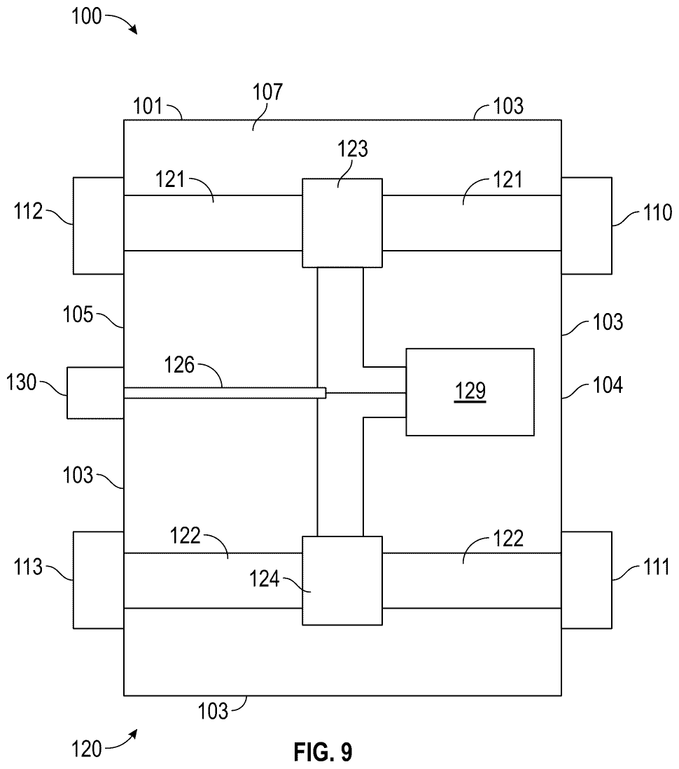

FIG. 9 shows a block diagram of the flow regulation subsystem (120) of the pool filling apparatus (100) according to the first illustrated embodiment. The pool filing apparatus comprises a housing (101) surrounding the flow regulation subsystem. The housing comprises a housing interior (107) and a plurality of sides (103) surrounding the housing interior. Disposed on a first side (104) is a first water inlet port (110) and a second water inlet port (111). Disposed on a second side (105) is a first water outlet port (112) and a second water outlet port (113). The first water outlet port fluidly couples with the first water inlet port by a first conduit (121). The second water outlet port fluidly couples with the second water inlet port by a second conduit (122). The first conduit comprises a first valve (123) disposed in-line therewith for stopping water discharged by the first water outlet port. Similarly, the second conduit comprises a second valve (124) disposed in-line therewith for stopping water discharged by the second water output port. The first and second valves receive signals to close from an open state to a closed state by a signal transmission line (126) disposed within the housing interior. The signal transmission line is electrically coupled to an externally accessible sensor (130) for measuring a water level in a pool or an equivalent vessel. When a desired water level has been achieved and detected, a signal is sent into the housing interior through the signal transmission line and sent to the first and second valves to change to the closed state to stop the flow of water. A power source (129) is disposed within the housing interior for providing power to the first and second valves. The power source is also configured to send power to the sensor which can include transmission through the signal transmission line.

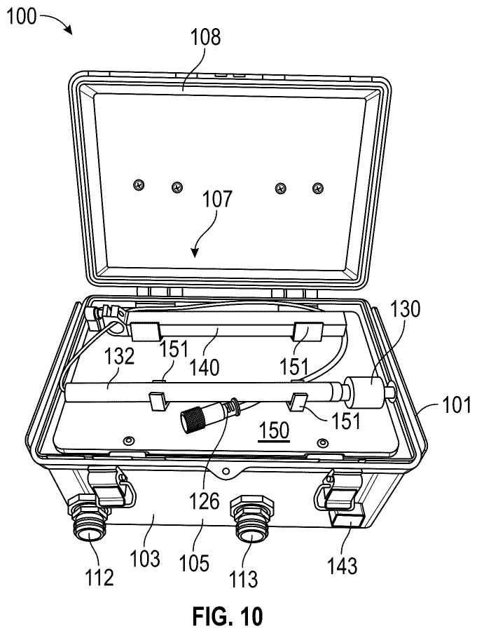

FIG. 10 shows a perspective view of a housing interior (107) of the pool filling apparatus (100) according to the first illustrated embodiment. A housing (101) surrounds the housing interior with sections including a plurality of sides (103) and a housing lid (108). Disposed on one of the plurality of sides at a second side (105) is a first water outlet port (112), a second water outlet port (113), and a slider receptacle (143). Upon opening of the housing lid a removable tray (150) is accessible for adding and removing detachable components including a slider (140) and a sensor assembly including a sensor (130), sensor stem (132), and sensor wire connector (145). Each detachable component is held in place by a fastening element (151). The removable tray is disposed above a flow regulation subsystem (FIG. 8; 120).

### FEATURE LIST

pool filling apparatus (100)
housing (101)
exterior surface (102)
plurality of sides (103)
first side (104)
second side (105)
bottom surface (106)
housing interior (107)
housing lid (108)
first water inlet port (110)
second water inlet port (111)
first water outlet port (112)
second water outlet port (113)
flow regulation subsystem (120)
first conduit (121)
second conduit (122)
first valve (123)
second valve (124)
solenoid (125)
signal transmission line (126)
sensor wire receptacle (127)
power inlet (128)
power source (129)
vertically adjustable sensor (130)
float sensor (131)
sensor stem (132)
proximal end (133)
distal end (134)
slider (140)
first end (141)
second end (142)
slider receptacle (143)
sensor mounting clamp (144)
sensor wire connector (145)
opening (146)
rear end (147)
removable tray (150)
fastening element (151)
pool (160)
pool edge (161)
pool interior (162)
external hose (170)

What is claimed is:

1. A pool filling apparatus, comprising:
a housing having an exterior surface and a housing interior surrounded by the exterior surface, the exterior surface comprising a plurality of sides, a bottom surface, and a hosing lid hingedly coupled to one of the plurality of sides, wherein the plurality of sides includes a first side and a second side opposite the first side;
a water inlet port disposed on the first side, the water inlet port configured to engage with an external hose for receiving and communicating water into the housing interior;
a water outlet port disposed on the second, wherein the water outlet port is fluidly coupled with the water inlet port, the water outlet port configured to discharge water into a pool;
a vertically adjustable sensor coupled to the housing, the vertically adjustable sensor adapted to sense a water height of the pool, wherein the vertically adjustable sensor is configurable into a position vertically below the bottom surface of the housing;
a slider receptable disposed on the second side;
a slider slidably engaged with the slider receptacle, the slider extending from a first end to a second end, wherein each portion of the first end is configured to slide within and be surrounded by the slider receptacle, the slider configured to detach and fully separate from each of the slider receptacle and the vertically adjustable sensor;
a flow regulation subsystem disposed within the housing interior, the flow regulation subsystem comprising:
a conduit disposed between the water inlet port and the water outlet port, and
a valve disposed in-line with the conduit between the water inlet port and water outlet port, wherein the valve is electrically coupled to the vertically adjustable sensor; and
a removable tray disposed within the housing interior above the flow regulation subsystem, the removable tray configured to hold the vertically adjustable sensor and the slider;
wherein the vertically adjustable sensor is configured to send a signal to the valve to change the valve from an open state to a closed state thereby preventing the water outlet port from discharging water.

2. The pool filling apparatus of claim 1, further comprising a plurality of water inlet ports, wherein each of the water inlet ports is disposed on the first side.

3. The pool filling apparatus of claim 2, further comprising a plurality of water outlet ports, wherein each of the water outlet ports is disposed on the second side.

4. The pool filling apparatus of claim 3, wherein the first side is in parallel alignment with the second side.

5. The pool filling apparatus of claim 1, further comprising a sensor mounting clamp disposed at the second end of the slider, the sensor mounting clamp configured to slidably couple with the vertically adjustable sensor.

6. The pool filling apparatus of claim 1, further comprising a sensor stem extending from a proximal end to a distal end, the distal end comprising the vertically adjustable sensor, wherein the sensor stem detachably couples to the slider.

7. The pool filing apparatus of claim 6, further comprising a sensor wire connector electrically coupled to each of the vertically adjustable sensor and the flow regulation subsystem.

8. The pool filling apparatus of claim 7, wherein the sensor wire connector extends through the proximal end of the sensor stem.

9. The pool filling apparatus of claim 7, wherein the sensor wire connector is externally accessible from the exterior surface of the housing.

10. A pool filling apparatus, comprising:
a housing having an exterior surface and a housing interior surrounded by the exterior surface, the exterior surface comprising a plurality of sides and a bottom surface, wherein the plurality of sides includes a first side and a second side;
a water inlet port disposed on the exterior surface, the water inlet port configured to engage with an external hose for receiving and communicating water into the housing interior;
a water outlet port disposed on the exterior surface, wherein the water outlet port is fluidly coupled with the water inlet port, the water outlet port configured to discharge water into a pool;
a vertically adjustable sensor coupled to the housing, the vertically adjustable sensor adapted to sense a water height of the pool, wherein the vertically adjustable sensor is configurable into a position vertically below the bottom surface of the housing; and
a flow regulation subsystem disposed within the housing interior, the flow regulation subsystem comprising:
a conduit disposed between the water inlet port and the water outlet port, and
a valve disposed in-line with the conduit between the water inlet port and water outlet port, wherein the valve is electrically coupled to the vertically adjustable sensor;
wherein the vertically adjustable sensor is configured to send a signal to the valve to change the valve from an open state to a closed state thereby preventing the water outlet port from discharging water.

11. The pool filling apparatus of claim 10, further comprising:
a slider receptable disposed on one of the plurality of sides;
a slider slidably engaged with the slider receptacle, the slider extending from a first end to a second end, wherein the first end is configured to slide within the slider receptacle; and
a sensor mounting clamp disposed at the second end of the slider, the sensor mounting clamp configured to slidably couple with the vertically adjustable sensor.

12. The pool filling apparatus of claim 11, wherein the slider is configured to detach and fully separate from the slider receptacle.

13. The pool filling apparatus of claim 11, wherein the vertically adjustable sensor is configured to detach and fully separate from the sensor mounting clamp.

14. The pool filling apparatus of claim 11, further comprising a sensor stem extending from a proximal end to a distal end, the distal end comprising the vertically adjustable sensor, wherein the sensor stem detachably couples to the sensor mounting clamp.

15. The pool filing apparatus of claim 14, further comprising a sensor wire connector electrically coupled to each of the vertically adjustable sensor and the flow regulation subsystem.

16. The pool filling apparatus of claim 15, wherein the sensor wire connector is externally accessible from the exterior surface of the housing.

17. The pool filling apparatus of claim 11, wherein the slider receptacle surrounds each portion of the first end.

18. The pool filling apparatus of claim 11, wherein the slider receptacle extends through each of first side and the second side wherein the first side is opposite the second side.

19. The pool filling apparatus of claim 11, wherein the slider receptacle further comprises an opening having a same periphery as the slider such that the slider is configured to slide horizontally in and out of the slider receptacle while preventing rotation of slider within the slider receptacle.

20. The pool filling apparatus of claim 10, further comprising a removable tray disposed within the housing interior above the flow regulation subsystem, the removable tray configured to hold the vertically adjustable sensor and the slider.
